(19) United States
(12) Patent Application Publication
(10) Pub. No.: US 2010/0194733 A1
(43) Pub. Date: Aug. 5, 2010

(54) MULTIPLE VOLTAGE LEVEL DRIVING FOR ELECTROPHORETIC DISPLAYS

(76) Inventors: Craig Lin, San Jose, CA (US); Tin Pham, San Jose, CA (US); Manasa Peri, Milpitas, CA (US); Bryan Chan, San Francisco, CA (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 12/695,817

(22) Filed: Jan. 28, 2010

Related U.S. Application Data
(60) Provisional application No. 61/148,746, filed on Jan. 30, 2009.

(51) Int. Cl. G06F 3/038; G09G 3/34

(52) U.S. Cl. 345/211; 345/107

(57) ABSTRACT

This application is directed to driving methods for electrophoretic displays. The driving methods comprise applying different voltages selected from multiple voltage levels, to pixel electrodes and optionally also to the common electrodes. In a preferred method, the different voltages are selected from a group consisting of 0V, at least two levels of positive voltage and at least two levels of negative voltage.

The present application claims the benefit of U.S. Provisional Application 61/148,746, filed Jan. 30, 2009, which is incorporated herein by reference in its entirety.

### TECHNICAL FIELD

The present invention relates to methods comprising applying a voltage selected from multiple voltage levels to drive an electrophoretic display.

### BACKGROUND OF THE INVENTION

An electrophoretic display (EPD) is a non-emissive device based on the electrophoresis phenomenon of charged pigment particles suspended in a solvent. The display usually comprises two plates with electrodes placed opposing each other. One of the electrodes is usually transparent. A suspension composed of a colored solvent and charged pigment particles is enclosed between the two plates. When a voltage difference is imposed between the two electrodes, the pigment particles migrate to one side or the other, according to the polarity of the voltage difference. As a result, either the color of the pigment particles or the color of the solvent may be seen at the viewing side. An EPD may be driven by a uni-polar or bi-polar approach.

However, the driving methods currently available pose a restriction on the number of grayscale outputs. This is due to the fact that display driver ICs and display controllers are limited in speed on the minimum pulse length that a waveform can have. While current active matrix display architectures utilize ICs that can generate pulse lengths down to 8 msec leading to electrophoretic displays which have shortened response time, even below 150 msec, the grayscale resolution seems to diminish due to the incapability of the system to generate shorter pulse lengths.

### SUMMARY OF THE DISCLOSURE

The present invention is directed to methods for driving an electrophoretic display, which method comprises applying different voltages selected from multiple voltage levels, to pixel electrodes and optionally also to the common electrode.

The method allows for multiple voltage levels, specifically, 0 volt, at least two levels of positive voltage and at least two levels of negative voltage.

The method can provide finer control over the driving waveforms and produce a better grayscale resolution.

The first aspect of the invention is directed to a driving method for a display device comprising an array of display cells wherein each of said display cells is sandwiched between a common electrode and a pixel electrode, which method comprises applying different voltages selected from a group consisting of 0 V, at least two levels of positive voltage and at least two levels of negative voltage, to the pixel electrode. In one embodiment, the different voltages are selected from a group consisting of 0V, three levels of positive voltage and three levels of negative voltage. In one embodiment, the different voltages are selected from a group consisting of 0V, −5V, −10V, −15V, +5V, +10V and +15V. In one embodiment, the voltage applied to the common electrode remains constant. In another embodiment, the method further comprises applying different voltages selected from a group consisting of 0V, at least two levels of positive voltage and at least two levels of negative voltage, to the common electrode. The different voltages applied to the common electrode are selected from a group consisting of 0V, three levels of positive voltage and three levels of negative voltage. In one embodiment, the different voltages applied to the common electrode are selected from a group consisting of 0V, −5V, −10V, −15V, +5V, +10V and +15V. In one embodiment, the display device is an electrophoretic display device.

### BRIEF DESCRIPTION OF THE DRAWINGS

FIG. 1 is a cross-section view of a typical electrophoretic display device.

FIG. 2 illustrates an example of a driving method of the present invention.

FIG. 3 illustrates an example of an alternative driving method of the present invention.

FIG. 4 is a table which shows the possible voltage combinations in a method of the present invention.

### DETAILED DESCRIPTION OF THE INVENTION

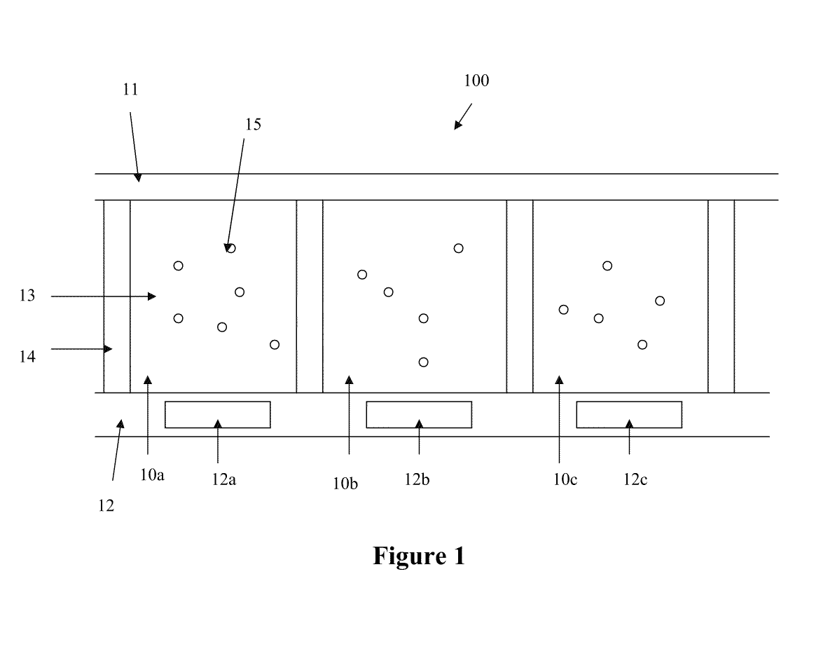

FIG. 1 illustrates a typical array of electrophoretic display cells 10a, 10b and 10c in a multi-pixel display 100 which may be driven by any of the driving methods presented herein. In FIG. 1, the electrophoretic display cells 10a, 10b, 10c, on the front viewing side, are provided with a common electrode 11 (which is usually transparent). On the opposing side (i.e., the rear side) of the electrophoretic display cells 10a, 10b and 10c, a substrate (12) includes discrete pixel electrodes 12a, 12b and 12c, respectively. Each of the pixel electrodes 12a, 12b and 12c defines an individual pixel of the multi-pixel electrophoretic display 100, in FIG. 1. However, in practice, a plurality of display cells (as a pixel) may be associated with one discrete pixel electrode. The pixel electrodes 12a, 12b, 12c may be segmented in nature rather than pixellated, defining regions of an image to be displayed rather than individual pixels. Therefore, while the term “pixel” or “pixels” is frequently used in this disclosure to illustrate driving implementations, the driving implementations are also applicable to segmented displays.

An electrophoretic fluid 13 is filled in each of the electrophoretic display cells 10a, 10b, 10c. Each of the electrophoretic display cells 10a, 10b, 10c is surrounded by display cell walls 14.

The movement of the charged particles in a display cell is determined by the voltage potential difference applied to the common electrode and the pixel electrode associated with the display cell.

As an example, the charged particles 15 may be positively charged so that they will be drawn to a pixel electrode (12a, 12b or 12c) or the common electrode 11, whichever is at an opposite voltage potential from that of charged particles 15. If the same polarity is applied to the pixel electrode and the common electrode in a display cell, the positively charged pigment particles will then be drawn to the electrode which has a lower voltage potential.

In another embodiment, the charged pigment particles 15 may be negatively charged.

The charged particles 15 may be white. Also, as would be apparent to a person having ordinary skill in the art, the charged particles may be dark in color and are dispersed in an electrophoretic fluid 13 that is light in color to provide sufficient contrast to be visually discernable.

The electrophoretic display 100 could also be made with a transparent or lightly colored electrophoretic fluid 13 and charged particles 15 having two different colors carrying opposite particle charges, and/or having differing electro-kinetic properties.

The electrophoretic display cells 10a, 10b, 10c may be of a conventional walled or partition type, a microencapsulted type or a microcup type. In the microcup type, the electrophoretic display cells 10a, 10b, 10c may be sealed with a top sealing layer. There may also be an adhesive layer between the electrophoretic display cells 10a, 10b, 10c and the common electrode 11.

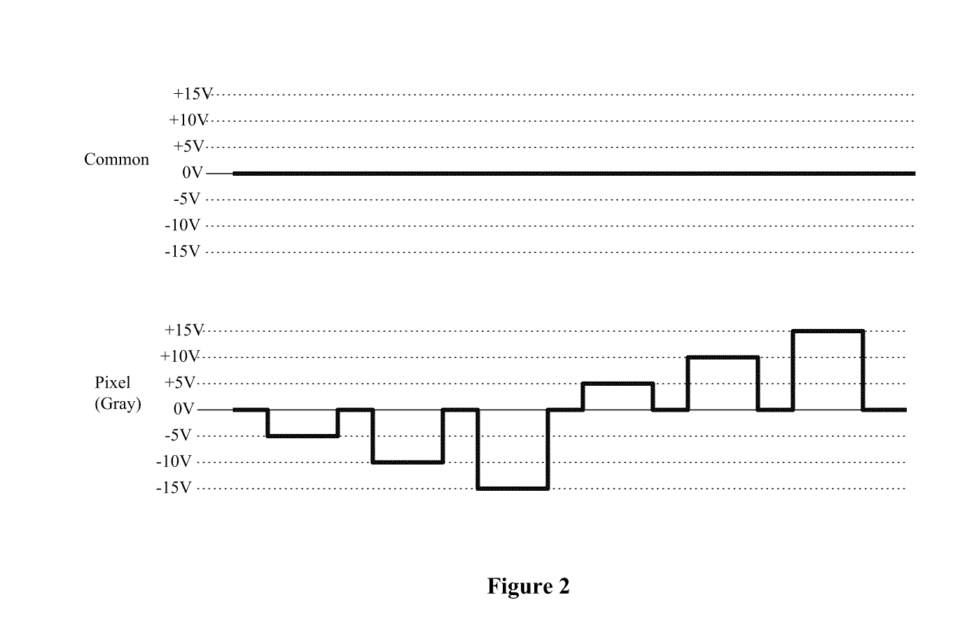

FIG. 2 shows a driving method of the present invention. In this example, the voltage applied to the common electrode remains constant at the 0 volt. The voltages applied to the pixel electrode, however, fluctuates between −15V, −10V, −5V, 0V, +5V, +10V and +15V. As a result, the charged particles associated with the pixel electrode would sense a voltage potential of −15V, −10V, −5V, 0V, +5V, +10V or +15V.

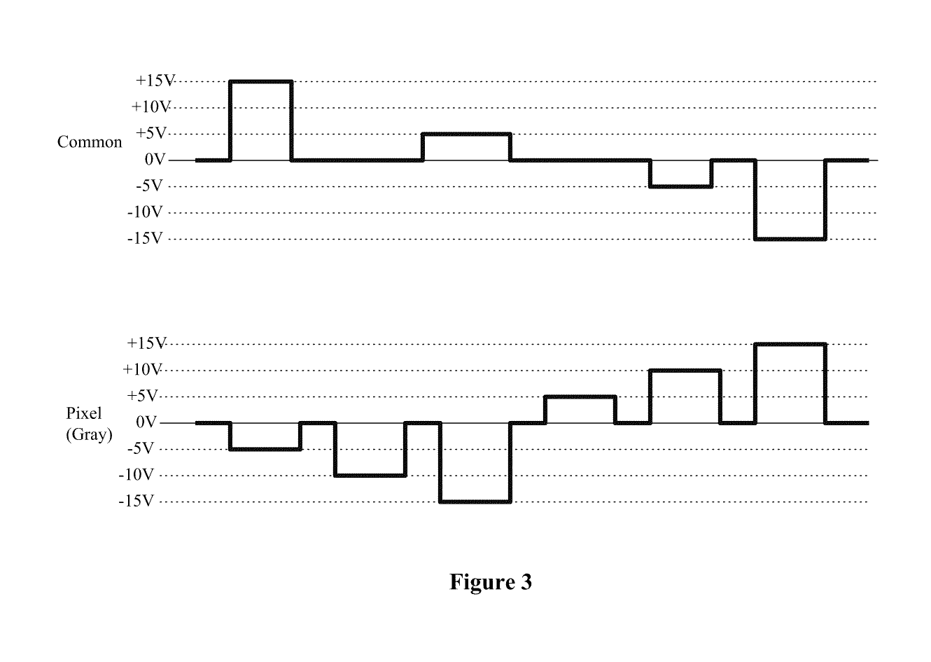

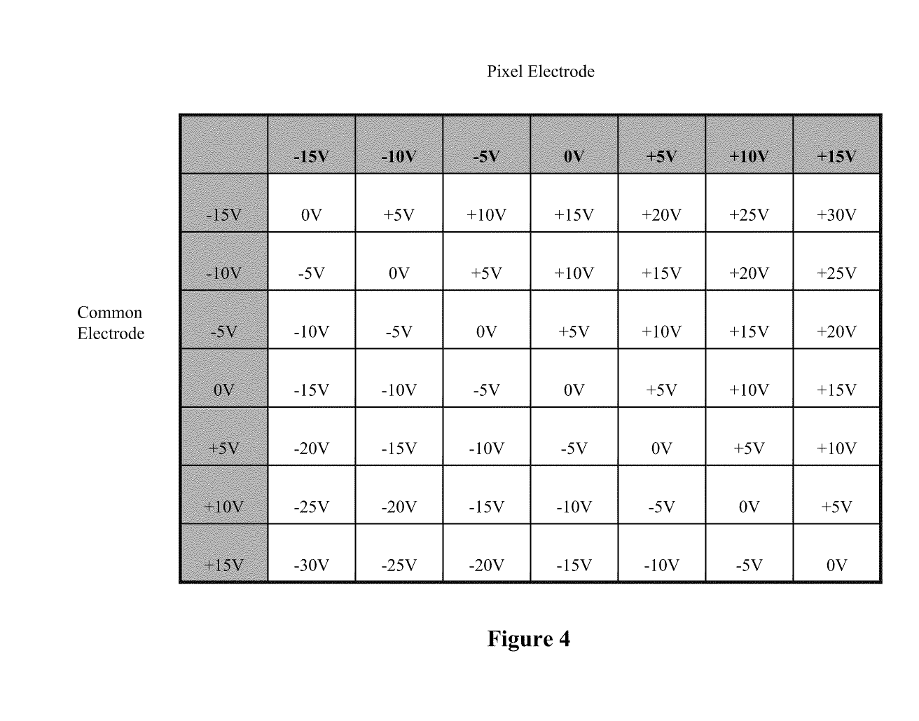

FIG. 3 shows an alternative driving method of the present invention. In this example, the voltage on the common electrode is also modulated. As a result, the charged particles associated with the pixel electrodes will sense even more levels of potential difference, −30V, −25V, −20V, −15V, −10V, −5V, 0V, +5V, +10V, +15V, +20V, +25V and +30V (see FIG. 4). While more levels of potential difference are sensed by the charged particles, more levels of grayscale may be achieved, thus a finer resolution of the images displayed.

The common electrode and the pixel electrodes are separately connected to two individual circuits and the two circuits in turn are connected to a display controller. In practice, the display controller issues signals to the circuits to apply appropriate voltages to the common and pixel electrodes respectively. More specifically, the display controller, based on the images to be displayed, selects appropriate waveforms and then issues signals, frame by frame, to the circuits to execute the waveforms by applying appropriate voltages to the common and pixel electrodes. The term “frame” represents timing resolution of a waveform.

Although the foregoing disclosure has been described in some detail for purposes of clarity of understanding, it will be apparent to a person having ordinary skill in that art that certain changes and modifications may be practiced within the scope of the appended claims. It should be noted that there are many alternative ways of implementing both the process and apparatus of the improved driving scheme for an electrophoretic display, and for many other types of displays including, but not limited to, liquid crystal, rotating ball, dielectrophoretic and electrowetting types of displays. Accordingly, the present embodiments are to be considered as exemplary and not restrictive, and the inventive features are not to be limited to the details given herein, but may be modified within the scope and equivalents of the appended claims.

What is claimed is:

1. A driving method for a display device comprising an array of display cells wherein each of said display cells is sandwiched between a common electrode and a pixel electrode, which method comprises applying different voltages selected from a group consisting of 0V, at least two levels of positive voltage and at least two levels of negative voltage, to the pixel electrode.

2. The driving method of claim 1 wherein said different voltages are selected from a group consisting of 0V, three levels of positive voltage and three levels of negative voltage.

3. The driving method of claim 2 wherein said different voltages are selected from a group consisting of 0V, −5V, −10V, −15V, +5V, +10V and +15V.

4. The driving method of claim 1 wherein the voltage applied to the common electrode remains constant.

5. The driving method of claim 1 further comprising applying different voltages selected from a group consisting of 0V, at least two levels of positive voltage and at least two levels of negative voltage, to the common electrode.

6. The driving method of claim 5 wherein said different voltages are selected from a group consisting of 0V, three levels of positive voltage and three levels of negative voltage.

7. The driving method of claim 6 wherein said different voltages are selected from a group consisting of 0V, −5V, −10V, −15V, +5V, +10V and +15V.

8. The driving method of claim 1 wherein said display device is an electrophoretic display device.
